(19) United States
(12) Patent Application Publication
(10) Pub. No.: US 2025/0219515 A1
(43) Pub. Date: Jul. 3, 2025

(54) MOTOR HAIRPIN EXPANSION DEVICE AND METHOD

(71) Applicants: Hyundai Motor Company, Seoul (KR); Kia Corporation, Seoul (KR); Hyundai Mobis Co., Ltd., Seoul (KR); Hyundai WIA Corporation, Changwon-si (KR)

(72) Inventors: Jun Won Lee, Hwaseong-si (KR); Sang Uk Jeon, Hwaseong-si (KR); Jae Ho Hwang, Hwaseong-si (KR); Kyoung Min Park, Hwaseong-si (KR); Min Ho Woo, Hwaseong-si (KR); Hyun Wook Nam, Suwon-si (KR); Yun Ho Hwang, Changwon-si (KR); Cheol Bae Park, Changwon-si (KR)

(21) Appl. No.: 18/939,920

(22) Filed: Nov. 7, 2024

(30) Foreign Application Priority Data
Jan. 3, 2024 (KR) 10-2024-0000985

(51) Int. Cl. H02K 15/04; H02K 15/02; H02K 15/085

(52) U.S. Cl. CPC H02K 15/0428; H02K 15/026; H02K 15/085; H02K 2215/00

(57) ABSTRACT

A device for expanding leg portions of hairpins of a motor on which the hairpins are wound by bending them radially outward for each layer, wherein, after the hairpins are restrained radially outward to reduce dispersion, an expansion process on the hairpins may be carried out, so that the hairpins may be bent equally during the expansion process, making it possible to secure constant expansion quality.

### CROSS-REFERENCE TO RELATED APPLICATIONS

This application claims the benefit of Korean Patent Application No. 10-2024-0000985, filed on Jan. 3, 2024, which application is hereby incorporated herein by reference.

### TECHNICAL FIELD

The present disclosure relates to a device and method for expanding leg portions of hairpins of a motor.

### BACKGROUND

It is known that the output of a motor is proportional to the number of turns of a coil wound on a stator core. Therefore, to improve the output of a motor without increasing the size of the motor, it may be considered to increase the space factor of a coil wound on a stator core.

As part of the above-mentioned method, recently, research has been conducted on a method of winding square coils with a square cross-section instead of circular coils with a circular cross-section. However, winding square coils is more difficult than circular coils.

to resolve such a problem, as a way to facilitate winding of square coils, a motor where a coil winding part is formed by inserting and fastening a number of separate hairpins into a stator coil and then joining each hairpin by welding (hereinafter, referred to as a “hairpin winding motor” for convenience of description) has been developed and used.

In the case of the hairpin winding motor as described above, a coil winding part of a stator core is formed by fastening roughly U-shaped hairpins to each slot of the stator core and then welding and joining the hairpins arranged in each layer of each slot.

Accordingly, in the case of the hairpin winding motor, an expansion process is performed to bend the ends of leg portions of hairpins outward in the radial direction.

The conventional expansion device does not have a separate device for restraining leg portions of hairpins before carrying out the expansion process. Hairpins are made by bending copper conductors using equipment such as a press, and, in the case of a specific hairpin motor, depending on the design factors of the motor, hairpins are arranged with an uneven distance therebetween in a slot of a stator, resulting in a lot of dispersion.

In this case, because the distance between the hairpins in the slot is not constant, it is not possible to secure constant quality during the expansion process, so it is necessary to find a way to solve this problem.

The information included in this Background of the present disclosure section is only for enhancement of understanding of the general background of the present disclosure and may not be taken as an acknowledgement or any form of suggestion that this information forms the prior art already publicly known, in use, or available.

### SUMMARY

The present disclosure relates to a device for expanding leg portions of hairpins of a motor on which the hairpins can be wound by bending them radially outward for each layer.

To solve the aforementioned problems, an embodiment of the present disclosure can provide a new motor hairpin expansion device and a new method of expanding a motor hairpin, where hairpins can be located in a slot by being moved from the inside of a stator to the outside in the radial direction and can be pushed out in the radial direction to reduce the dispersion of the hairpins so that a constant distance between the hairpins can be secured after the expansion process on the hairpins is carried out.

According to at least one embodiment of the present disclosure, a motor hairpin expansion device for expanding hairpins of a stator may include a first expansion unit comprising a plurality of first expansion tools arranged in a circumferential direction, each of the plurality of first expansion tools can be movable in a radial direction and comprising a first hairpin receiving groove configured to receive a hairpin, a second expansion unit comprising a plurality of second expansion tools arranged in the circumferential direction, each of plurality of second expansion tools comprising a second hairpin receiving groove at one end of the first hairpin receiving groove, a transfer unit configured to transfer the stator, and a guide unit comprising a plurality of third expansion tools, each of the plurality of third expansion tools configured to push the hairpins outward in the radial direction.

According to at least one embodiment of the present disclosure, the plurality of third expansion tools may protrude radially and respectively comprise a round outer surface to support the inside of the hairpin.

According to at least one embodiment of the present disclosure, the diameter of the plurality of third expansion tools may be 90 percent or less of the inner diameter of the stator.

According to at least one embodiment of the present disclosure, the motor hairpin expansion device may further include a shuttle unit having a seating portion on which the stator transferred by the transfer unit is seated.

According to at least one embodiment of the present disclosure, the first expansion unit may include a first actuator configured to provide a driving force for moving the plurality of first expansion tools back and forth, and the shuttle unit may further include a second actuator to move the seating portion in the vertical direction.

According to at least one embodiment of the present disclosure, the guide unit may further include a third actuator configured to move the plurality of third expansion tools up and down and radially outward.

According to at least one embodiment of the present disclosure, the plurality of first expansion tools may move back and forth on the top of the plurality of second expansion tools.

According to at least one embodiment of the present disclosure, the second hairpin receiving groove may have a radially open outer side.

According to at least one embodiment of the present disclosure, the transfer unit may further include a plurality of fixing parts configured to move inside of the stator outward in the radial direction and come into contact with an inner surface of the stator.

According to at least one embodiment of the present disclosure, a method of expanding hairpins of a stator of a motor may include preparing a stator with hairpins wound thereon, carrying the stator through a transfer unit and seating it on a shuttle unit, inserting at least some of the plurality of hairpins into first hairpin receiving grooves of first expansion tools of a first expansion unit and inserting some of the plurality of remaining hairpins into second hairpin receiving grooves of second expansion tools of a second expansion unit, when the shuttle unit moves downward, moving a guide unit upward, pushing the hairpins wound on the stator radially outward by using a plurality of third expansion tools of the guide unit, and driving the first expansion unit and the second expansion unit to move the first expansion tool and the second expansion tool radially outward, thereby bending the hairpins radially outward.

According to the present disclosure, after hairpins are restrained radially outward to reduce dispersion, the expansion process on the hairpins may be carried out, so that the hairpins may be bent equally during the expansion process, making it possible to secure constant expansion quality.

Advantages of an embodiment of the present disclosure are not necessarily limited to the above-mentioned advantages, and the following description can allow a person having ordinary skill in the technical field to which the present disclosure pertains to understand other advantages not mentioned above.

The methods and apparatuses of an embodiment of the present disclosure can have other features and advantages that can be apparent from or can be set forth in more detail in the accompanying drawings, which are incorporated herein, and the following Detailed Description, which together serve to explain certain principles of the present disclosure.

### BRIEF DESCRIPTION OF THE DRAWINGS

FIG. 1A is a side view of a hairpin that can be used for a motor, according to an embodiment of the present disclosure.

FIG. 1B a perspective view of a stator core that can be used for a motor, according to an embodiment of the present disclosure.

FIG. 2 a side view of a hairpins coupled with a stator core, according to an embodiment of the present disclosure.

FIG. 3 is a cross-sectional view taken along line A-A in FIG. 2.

FIG. 4 is a perspective view of a first expansion unit and a guide unit of a motor hairpin expansion device according to an embodiment of the present disclosure.

FIG. 5A is a partial perspective view a first expansion tool of a motor hairpin expansion device according to an embodiment of the present disclosure.

FIG. 5B is a partial top view a second expansion tool of a motor hairpin expansion device according to an embodiment of the present disclosure.

FIG. 6 is a side view of a motor hairpin expansion device according to an embodiment of the present disclosure.

FIG. 7 is a cut-away perspective view of the motor hairpin expansion device in FIG. 6 from direction “A.”

FIG. 8 shows hairpins expanded by a motor hairpin expansion device according to an embodiment of the present disclosure.

FIG. 9 is a cut-away side view of a first expansion unit, a second expansion unit, and a shuttle unit of a motor hairpin expansion device according to an embodiment of the present disclosure.

FIG. 10 is an enlarged view of portion “B” in FIG. 9.

FIG. 11 is a top plan view of a first expansion unit and a guide unit of a motor hairpin expansion device according to an embodiment of the present disclosure.

FIG. 12 is a perspective view of a guide unit of a motor hairpin expansion device according to an embodiment of the present disclosure.

FIG. 13A is a top view of a guide unit of a motor hairpin expansion device according to an embodiment of the present disclosure.

FIG. 13B is a side view of a guide unit of a motor hairpin expansion device according to an embodiment of the present disclosure.

It may be understood that the appended drawings are not necessarily to scale, can be presenting a somewhat simplified representation of various features illustrative of principles of the present disclosure. The specific design features of an embodiment of the present disclosure as included herein, including, for example, specific dimensions, orientations, locations, and shapes, can be determined in part by a particularly intended application and use environment.

In the figures, same reference numerals can refer to same or equivalent parts of example embodiments of the present disclosure throughout the several figures of the drawing.

### DETAILED DESCRIPTION OF ILLUSTRATIVE EMBODIMENTS

Because various changes can be made to the present disclosure and a range of embodiments can be made for the present disclosure, specific example embodiments will be illustrated and described in the drawings. Color versions of the figures can be found in the publication of the Korean priority document. However, this is not intended to necessarily limit the present disclosure to the specific example embodiments, and it can be understood that the present disclosure can include all changes, equivalents, and substitutes within the technology and the scopes of the present disclosure.

Terms containing ordinal numbers such as “first” and “second” may be used to describe various components, but the components are not necessarily limited by such terms. The above-mentioned terms can be used merely for the purpose of distinguishing one component from another component.

The expression “and/or” can be used to include all possible combinations of multiple items being addressed. For example, by “A and/or B,” all three possible combinations can be meant: “A,” “B,” and “A and B.”

When a component is said to be “coupled” or “connected” to another component, it can be that the component may be directly coupled or connected to the other component or there may be other components therebetween. On the other hand, when a component is referred to as being “directly coupled” or “directly connected” to another component, it can be that there are no other components therebetween.

When each layer or film, region, pattern, or structure is described to be “on/above” or “under/below” each substrate, layer or film, region, pad, or pattern in the description of the embodiments of the present disclosure, it can be that it is directly thereon or thereunder, or thereon or thereunder with another layer therebetween. Whether one component is “on/above” or “under/below” another component can be determined for convenience based on how they are shown in the drawing. Such expressions can be used merely for convenience to indicate how components are positioned with respect to each other, and should not be understood as necessarily limiting the actual positions of the components. For example, the statement “B on A” can simply indicate that B is positioned on A in the drawing, unless otherwise stated or the nature of A or B does not necessarily require that A be located on B, and, in actual products, etc., B may be positioned under A, or B and A may be placed side by side.

In addition, a thickness or size of each layer or film, region, pattern, or structure may be changed in the drawings for clarity and convenience of description, and the actual size thereof may not be entirely reflected.

Terms used herein can be used merely to describe specific embodiments and are not intended to necessarily limit the present disclosure. Expressions in the singular form can include also the plural form unless they clearly mean otherwise in the context. In the present disclosure, expressions such as “comprise” or “have” are intended to indicate the presence of features, numbers, steps, operations, components, parts, or combinations thereof described herein, and should not be understood as precluding the possibility of the presence or the addition of one or more other features, numbers, steps, operations, components, parts, or combinations thereof.

Terms used herein, including technical or scientific terms, can have meanings commonly understood by a person having ordinary skill in the technical field to which the present disclosure pertains. Terms defined in commonly used dictionaries can be interpreted as having meanings consistent with meanings they have in the context of the relevant technology, and should not be interpreted in an ideal or overly formal sense unless explicitly defined in the present disclosure.

Hereinafter, example embodiments of the present disclosure will be described in detail with reference to the attached drawings. Components identical or corresponding to one other can have a same reference number regardless of their drawing reference numbers, and the description thereof may not be repeatedly provided.

A motor hairpin expansion device for expanding hairpins of a stator on which the hairpins are wound may include a first expansion unit 150, a second expansion unit 210, a transfer unit 270, and a guide unit 300.

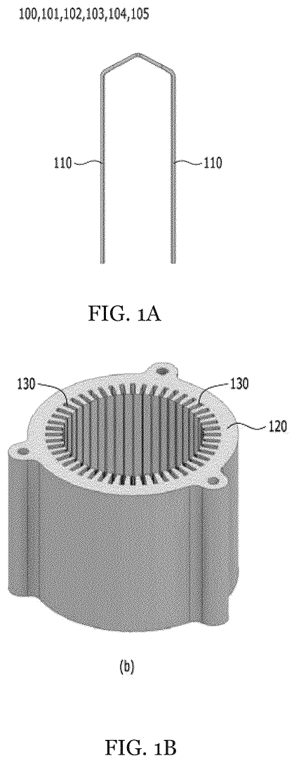

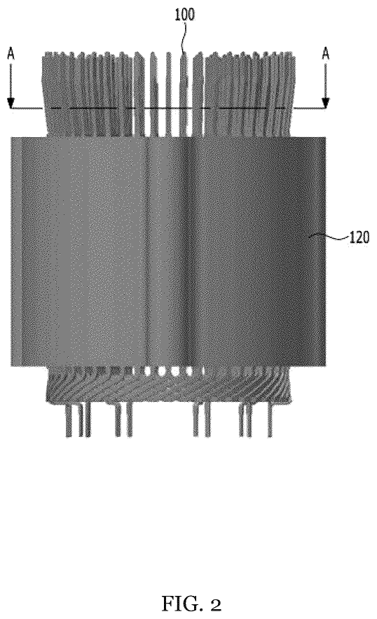

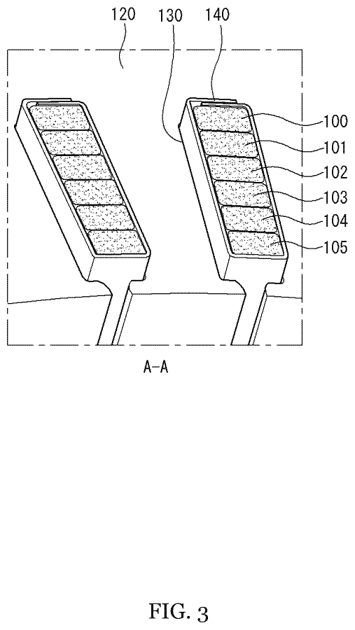

Before describing the motor hairpin expansion device, the hairpin and a stator core will be described. A conductor of the hairpin may be U-shaped with two leg portions 110, as shown in FIG. 1A. The U-shaped hairpin may be installed on a stator core 120, and a plurality of slots 130 may be formed on the stator core 120 as shown in FIG. 1B. Typically, 48 slots 130 may be formed, and a plurality of hairpins 100, 101, 102, 103, 104, and 105 may be installed in the slot 130 in which insulating paper 140 has been installed, as shown in FIG. 3. As shown in FIG. 3, a plurality of hairpins may be installed in one slot 130. In an example embodiment of the present embodiment, six hairpins may be installed. The number of the hairpins 100, 101, 102, 103, 104, and 105 installed in the slot 130 may vary depending on the type/size of motor.

The first expansion unit 150 can move in the radial direction and can have a plurality of hairpins at the end.

The first expansion unit 150 may be moved in the radial direction, and a plurality of first expansion tools 160 that have first hairpin receiving grooves 170 formed at the ends thereof and accommodating the plurality of hairpins 100, 101, 102, 103, 104, and 105 may be arranged in the circumferential direction on the first expansion unit 150. In an embodiment, the number of the first expansion tools 160 may be 48, which is the same as the number of the slots 130 of the stator core 120.

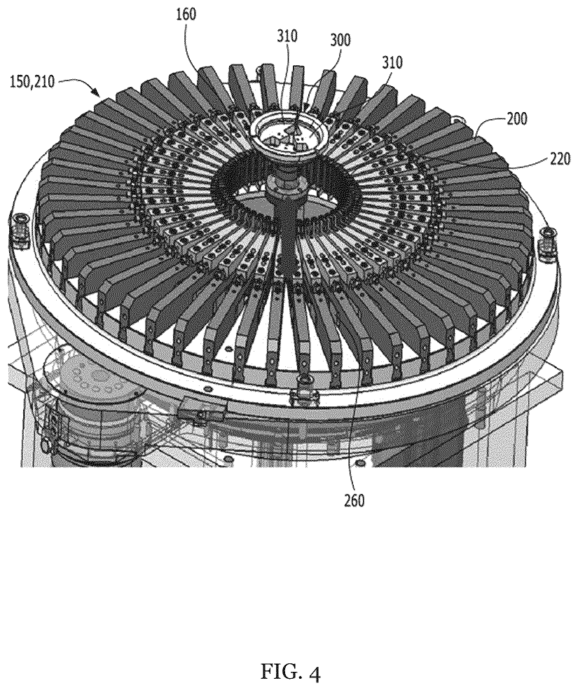

The first expansion tools 160 may be densely arranged in a circular shape as shown in FIG. 4. The first expansion tool 160 may expand the leg portion 110 of the hairpin while moving back and forth in the radial direction.

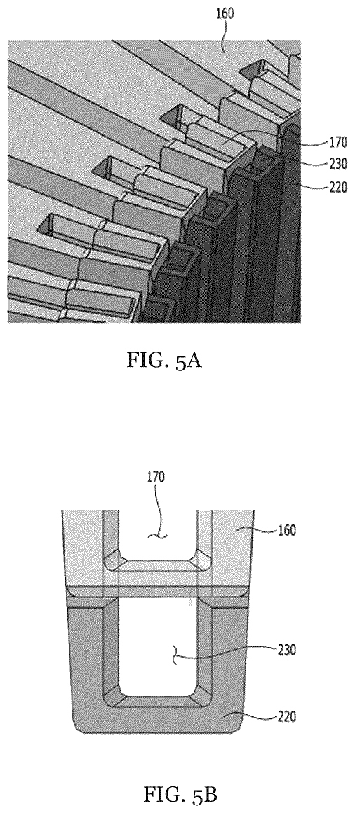

Referring to FIGS. 5A and 5B, the first hairpin receiving groove 170 may be formed at the end of the first expansion tool 160 in the longitudinal direction. Specifically, the first hairpin receiving groove 170 may be formed to vertically penetrate the inner end in the radial direction.

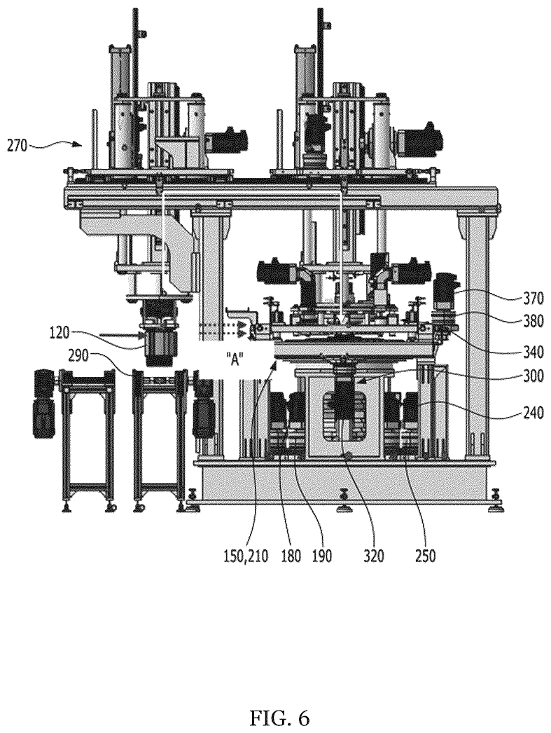

As shown in FIG. 6, the first expansion unit 150 may include a first actuator that provides a driving force so that the plurality of first expansion tools 160 may move back and forth. The first actuator may be a first servo motor 180 and a first servo cylinder 190. The first servo cylinder 190 may provide a driving force for the first expansion tool 160 to move back and forth. Specifically, as shown in FIG. 4, the first expansion tools 160 may be installed on a plurality of first transfer rails 200, which can be arranged at the radial outer end in the circumferential direction, and may pull outward the leg portion 110 of the hairpin protruding downward from the stator core 120 in the radial direction to bend the end of the leg portion 110 of the hairpin while moving outward in the radial direction by the first transfer rails 200.

As shown in FIGS. 5A and 5B, the plurality of first expansion tools 160 may move back and forth while overlapping a plurality of second expansion tools 220 on the top of the plurality of second expansion tools 220, which will be described below. It will be described below how the first expansion tool 160 may move back and forth while overlapping the plurality of second expansion tools 220 on the top thereof.

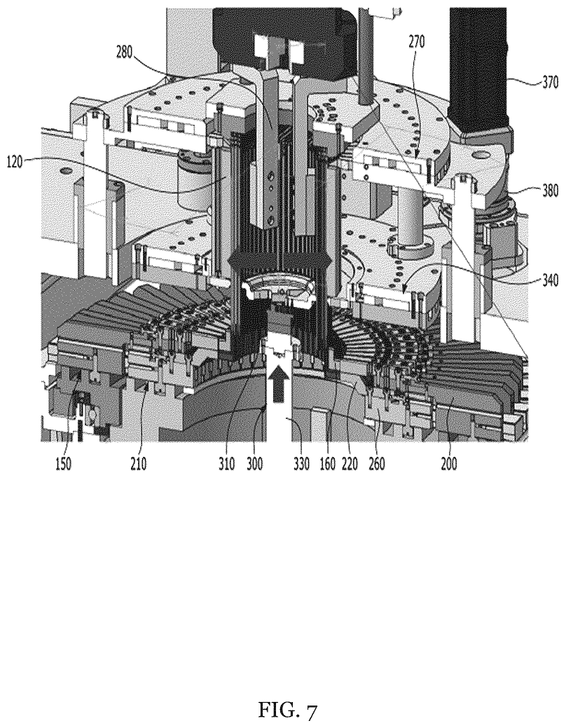

As shown in FIG. 7, on the second expansion unit 210, the plurality of second expansion tools 220 having second hairpin receiving grooves 230 formed at the ends of the first hairpin receiving grooves 170 may be disposed in the circumferential direction. The second expansion tool 220 may be placed below the first expansion tool 160, and, when the first expansion tool 160 moves outward in the radial direction, the second expansion tool 220 may also move outward in the radial direction while overlapping the first expansion tool 160.

As shown in FIG. 6, the second expansion unit 210 may include a second actuator that provides a driving force so that the plurality of second expansion tools 220 may move back and forth. The second actuator may be a second servo motor 240 and a second servo cylinder 250. The second servo cylinder 250 may provide a driving force for the second expansion tool 220 to move back and forth.

Specifically, as shown in FIG. 4, the second expansion tools 220 may be installed on a plurality of second transfer rails 260, which can be arranged at the radial outer end in the circumferential direction, and may pull outward the leg portion 110 of the hairpin protruding downward from the stator core 120 in the radial direction to bend the end of the leg portion 110 of the hairpin while moving outward in the radial direction by the second transfer rails 260.

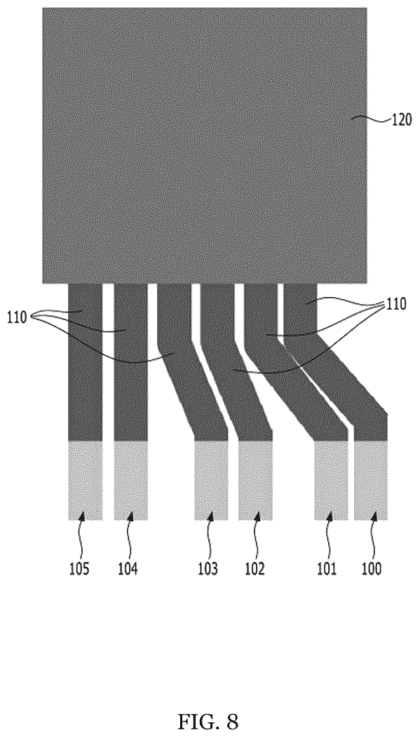

As a result, as shown in FIG. 8, among the plurality of hairpins arranged radially in the slot 130 of the stator, the hairpin on the outermost side of the slot 130 may be bent the most and expanded, and the hairpin in the middle may be bent the next most and expanded.

To be specific, assuming that six hairpins have been installed in the slot 130, the leg portions 110 of the first hairpin 100 and the second hairpin 101 on the outermost radial side of the slot 130 may be bent the most and expanded as the first expansion tools 160 moves outward in the radial direction.

In addition, the third hairpin 102 and the fourth hairpin 103 may be expanded by being bent to around half the extent to which the first hairpin 100 and the second hairpin 101 are bent as the second expansion tools 220 moves outward in the radial direction.

As a result, the first hairpin 100 and the second hairpin 101 may be spaced apart from the third hairpin 102 and the fourth hairpin 103, and the third hairpin 102 and the fourth hairpin 103 may be spaced apart from the fifth hairpin 104 and the sixth hairpin 105, which have not been bent.

The number of the plurality of second expansion tools 220 may be the same as the number of the plurality of first expansion tools 160. Referring to FIGS. 5A and 5B, the second hairpin receiving groove 230 formed at the inner end of the second expansion tool 220 may have a radially open outer side. Therefore, when the first expansion tool 160 and the second expansion tool 220 are combined, one open side of the second hairpin receiving groove 230 may be closed.

In addition, referring to FIG. 7, the second hairpin receiving groove 230 may protrude upward, and the height of the protruding portion may be the same as the height of the first expansion tool 160 having the first hairpin receiving groove 170.

The transfer unit 270 may transfer the stator core 120 on which the hairpin is wound. Referring to FIG. 7, the transfer unit 270 may further include a plurality of fixing parts 280 that move from the inside of the stator to the outside in the radial direction and come into contact with the inner surface of the stator.

Referring to FIG. 6, the transfer unit 270 may serve to move the stator on which the hairpins are wound from a conveyor 290 and seat it on a shuttle unit 340. The shuttle unit 340 will be described below.

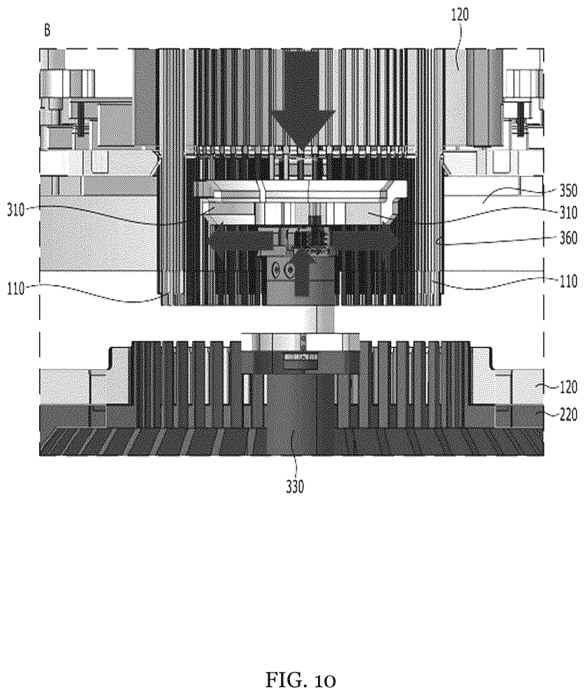

A guide unit 300 may be placed between the first expansion unit 150 and the second expansion unit 210, and may include a plurality of third expansion tools 310 that move in the radial direction and push the plurality of hairpins outward in the radial direction to bring them into close contact with each other, as shown in FIG. 10. The guide unit may include a third actuator at the bottom so that the plurality of third expansion tools 310 may move up and down and radially outward.

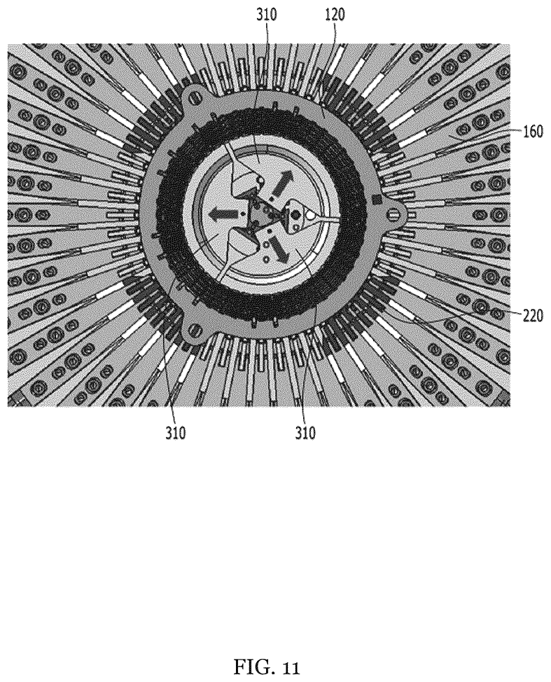

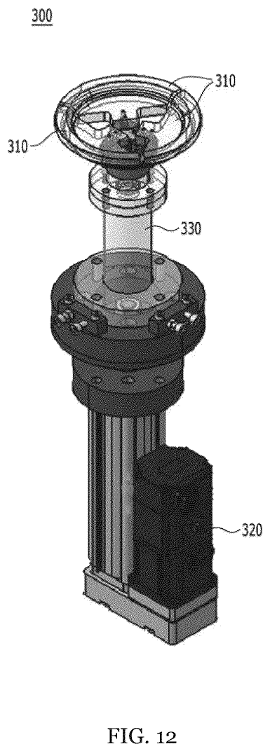

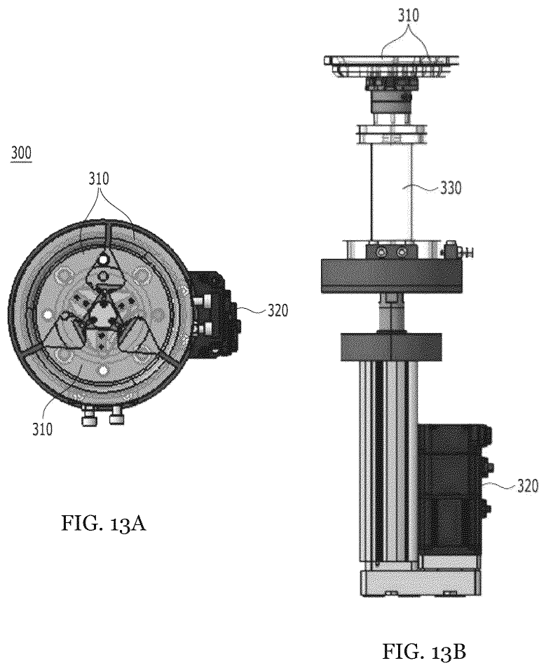

The plurality of third expansion tools 310 may protrude radially as shown in FIG. 11, and may serve to push the hairpins outward in the radial direction and bring them into close contact with each other so that no space is created therebetween. To this end, the outer side of the plurality of third expansion tools 310 may have the same circumference as the outer circumference of the stator, as shown in FIG. 12 and FIG. 13A.

In addition, referring to FIG. 13A, when the plurality of third expansion tools 310 are contracted radially inward, the diameter of the plurality of third expansion tools 310 may be approximately 90 percent or more of the inner diameter of the stator. As shown in FIG. 11, as the plurality of third expansion tools 310 move outward in the radial direction, the space between the plurality of third expansion tools 310 may widen.

In particular, when the plurality of third expansion tools 310 are contracted and the inner diameter thereof is smaller, the plurality of third expansion tools 310 may move significantly outward, widening the gap therebetween, so that the hairpins may not come into close contact with each other in the outward direction.

To prevent such a problem, it may be desirable to ensure that, when the plurality of third expansion tools 310 are contracted radially inward, the diameter thereof is almost the same as the inner diameter of the stator. In other words, it may be desirable for the diameter of the contracted third expansion tool to be approximately 90 percent or more of the inner diameter of the stator core 120.

As shown in FIG. 12, the third actuator may include a chuck cylinder (not shown) that moves the third expansion tool 310 in the radial direction and a third servo cylinder 330 that moves the plurality of third expansion tools 310 in the vertical direction. The chuck cylinder and the third servo cylinder 330 may be driven by a third servo motor 320.

The third servo motor 320 may drive a hydraulic pump, and the chuck cylinder and the third servo cylinder may include oil for hydraulic drive. In some embodiments, the chuck cylinder and the third servo cylinder may be driven by pneumatic pressure.

The motor hairpin expansion device may further include the shuttle unit as shown in FIGS. 7, 9, and 10. The shuttle unit 340 may include a seating portion 350 on which the stator core 120 transferred by the transfer unit 270 may be seated. The seating portion 350 may include a seating hole 360 so that the leg portions 110 of the plurality of hairpins protruding from the stator core 120 may pass through the seating hole 360 and may be coupled to the first expansion unit 150 and the second expansion unit 210 and the guide unit 300 may be moved into the stator.

The shuttle unit 340 may include a fourth actuator to move the seating portion 350 in the vertical direction. The fourth actuator may be a fourth servo cylinder 380 that operates hydraulically. The fourth servo cylinder 380 may be driven by a fourth servo motor 370.

Next, a method of expanding a motor hairpin according to an embodiment of the present disclosure will be described.

First, the stator with the stator slot 130 in which hairpins are installed may be prepared. The stator with the hairpins may be seated on the conveyor 290 to be carried as shown in FIG. 6.

The stator transferred through the conveyor 290 may be lifted and placed on the shuttle unit 340 by the transfer unit 270.

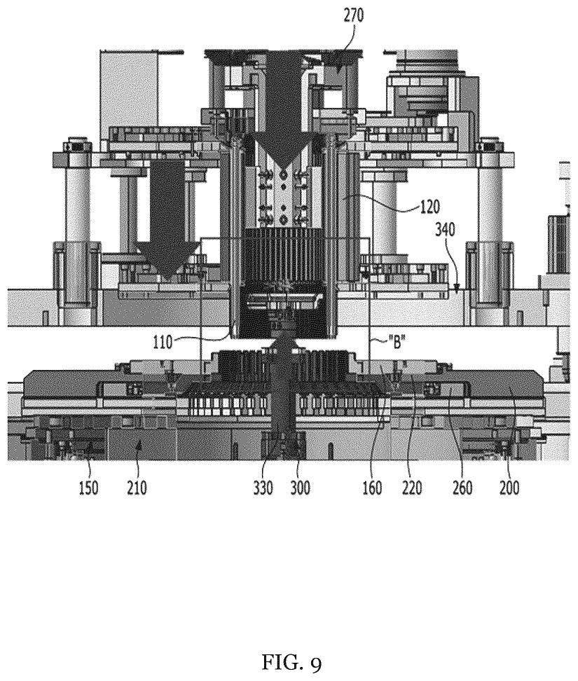

As shown in FIG. 9, as the shuttle unit 340 moves downward, the leg portions 110 of some of the plurality of hairpins installed on the stator may be inserted into the first hairpin receiving grooves 170 of the first expansion tools 160.

In addition, as the shuttle unit 340 moves downward, the leg portions 110 of some of the plurality of hairpins installed on the stator may be inserted into the second hairpin receiving grooves 230 of the second expansion tools 220.

When the leg portions 110 of the hairpins have been inserted into the first hairpin receiving grooves 170 and the second hairpin receiving grooves 230, the guide unit 300 may move upward and may be positioned in the axial lower part of the stator.

The plurality of third expansion tools 310 of the guide unit 300 may move outward in the radial direction and push the ends of the leg portions of the hairpins wound on the stator outward in the radial direction to bring them into close contact with the inner surface of the stator slot 130.

The first expansion tool 160 may move radially outward when the first expansion unit 150 is driven, so that the end of the leg portion 110 of the hairpin may be bent radially outward.

When the leg portion 110 of the hairpin has been first bent, the second expansion tool 220 having the second hairpin receiving groove 230 on the second expansion unit 210 may be moved radially outward, so that the end of the leg portion 110 of the hairpin may be moved radially outward.

The description has been made focusing on example embodiments of the present disclosure, but the example embodiments are only illustrative and are not intended to necessarily limit the present disclosure. A person having ordinary skill in the art can understand that various modifications and applications that have not been described above can be made to the example embodiments. For example, each of the components specifically described for the example embodiments can be modified. In addition, the differences resulting from such modifications and applications can be deemed to be within scopes of the present disclosure defined by the appended claims.

What is claimed is:

1. A motor hairpin expansion device for expanding hairpins of a stator, the device comprising:
a first expansion unit comprising a plurality of first expansion tools arranged in a circumferential direction, each of the plurality of first expansion tools being movable in a radial direction and comprising a first hairpin receiving groove configured to receive a hairpin;
a second expansion unit comprising a plurality of second expansion tools arrange in the circumferential direction, each of the plurality of second expansion tools comprising a second hairpin receiving groove at one end of the first hairpin receiving groove;
a transfer unit configured to transfer the stator; and
a guide unit comprising a plurality of third expansion tools, each of the plurality of third expansion tools being configured to push the hairpins outward in the radial direction.

2. The device of claim 1, wherein the plurality of third expansion tools protrude radially and each respectively comprise a round outer surface configured to support the hairpins.

3. The device of claim 1, wherein a diameter of the plurality of third expansion tools is 90 percent or less of an inner diameter of the stator.

4. The device of claim 1, further comprising a shuttle unit comprising a seating portion configured such that the stator can be seated on.

5. The device of claim 4, wherein the first expansion unit comprises a first actuator configured to provide a driving force for moving the plurality of first expansion tools back and forth, and wherein the shuttle unit further comprises a second actuator configured to move the seating portion in a vertical direction.

6. The device of claim 1, wherein the guide unit further comprises a third actuator configured to move the plurality of third expansion tools up and down and radially outward.

7. The device of claim 1, wherein the plurality of first expansion tools is configured to move back and forth on top of the plurality of second expansion tools.

8. The device of claim 1, wherein the second hairpin receiving groove has a radially open outer side.

9. The device of claim 1, wherein the transfer unit further comprises a plurality of fixing parts configured to move inside of the stator outward in the radial direction and come into contact with an inner surface of the stator.

10. A method of expanding hairpins of a stator of a motor, the method comprising:
inserting a first group of the hairpins into first hairpin receiving grooves of first expansion tools of a first expansion unit;
inserting a second group of the hairpins into second hairpin receiving grooves of second expansion tools of a second expansion unit;
pushing the hairpins wound on the stator radially outward by using third expansion tools of a guide unit; and
driving the first expansion unit and the second expansion unit to move the first expansion tools and the second expansion tools radially outward, thereby bending the first group of the hairpins and the second group of the hairpins radially outward.

11. The method of claim 10, further comprising:
preparing the stator with the hairpins wound thereon;
carrying the stator through a transfer unit; and
seating the stator on a shuttle unit.

12. The method of claim 11, wherein the inserting of the first group of the hairpins into the first hairpin receiving grooves of the first expansion tools and the inserting of the second group of the hairpins into the second hairpin receiving grooves of the second expansion tools are in response to the shuttle unit moving in a first direction.

13. The method of claim 12, further comprising moving the guide unit in a second direction, wherein the second direction is opposite the first direction.

14. The method of claim 13, wherein the first direction is downward and wherein the second direction is upward.

15. The method of claim 10, wherein the bending of the first group of the hairpins and the second group of the hairpins radially outward is such that the first group of the hairpins is bent more radially outward than the second group of the hairpins.

16. A method of expanding hairpins of a stator during manufacturing of an electric motor, the method comprising:
inserting a first group of the hairpins into first hairpin receiving grooves of first expansion tools of a first expansion unit;
inserting a second group of the hairpins into second hairpin receiving grooves of second expansion tools of a second expansion unit, wherein the first hairpin receiving grooves are more radially outward than the second hairpin receiving grooves;
inserting a guide unit into a central region of the hairpins, wherein the guide unit includes third expansion tools, such that the hairpins surround the third expansion tools;
pushing the hairpins radially outward using the third expansion tools of the guide unit, wherein the first expansion tools and the second expansion tools are more radially outward than the third expansion tools; and
driving the first expansion unit and the second expansion unit to move the first expansion tools and the second expansion tools radially outward, thereby bending the first group of the hairpins and the second group of the hairpins radially outward.

17. The method of claim 16, wherein the bending of the first group of the hairpins and the second group of the hairpins radially outward is such that the first group of the hairpins is bent more radially outward than the second group of the hairpins.

18. The method of claim 17, further comprising:
preparing the stator with the hairpins wound thereon;
carrying the stator through a transfer unit; and
seating the stator on a shuttle unit.

19. The method of claim 18, wherein the inserting of the first group of the hairpins into the first hairpin receiving grooves of the first expansion tools and the inserting of the second group of the hairpins into the second hairpin receiving grooves of the second expansion tools are in response to the shuttle unit moving in a first direction, and
wherein the method further comprises moving the guide unit in a second direction, wherein the second direction is opposite the first direction.

20. The method of claim 16, further comprising pressing the second expansion tools radially outward against the first expansion tools such that the second group of the hairpins in the second hairpin receiving grooves are framed by and bound by the second expansion tools and the first expansion tools.
